(19) United States
(12) Patent Application Publication
(10) Pub. No.: US 2026/0015041 A1
(43) Pub. Date: Jan. 15, 2026

(54) VEHICLE PANEL STRUCTURE

(71) Applicant: Honda Motor Co., Ltd., Tokyo (JP)

(72) Inventors: Masayasu YOSHIDA, Saitama (JP); Hiroyo MIYANAGA, Saitama (JP); Satoru KAWABE, Saitama (JP); Ryuki FUJITA, Saitama (JP); Hisashi SUZUKI, Saitama (JP)

(73) Assignee: Honda Motor Co., Ltd., Tokyo (JP)

(21) Appl. No.: 19/263,389

(22) Filed: Jul. 8, 2025

(30) Foreign Application Priority Data
Jul. 10, 2024 (CN) 202410923137.8

(51) Int. Cl. B62D 21/15

(52) U.S. Cl. CPC B62D 21/15

(57) ABSTRACT

A vehicle panel structure includes a panel, formed by a double-layer panel structure having a first panel and a second panel, where the panel has concave ribs and convex ribs formed to be concavo-convex in a normal direction of the panel, the concave ribs or the convex ribs formed on the first panel are first ribs, the concave ribs or the convex ribs formed on the second panel are second ribs, each first rib and each second rib correspond to each other respectively, and overlap in the normal direction of the panel, and when one of the corresponding first ribs and second ribs is one of the concave ribs and the convex ribs, the other one of the corresponding first ribs and second ribs is the other one of the concave ribs and the convex ribs.

### CROSS-REFERENCE TO RELATED APPLICATION

This application claims the priority benefit of China application serial no. 202410923137.8, filed on Jul. 10, 2024. The entirety of the above-mentioned patent application is hereby incorporated by reference herein and made a part of this specification.

### BACKGROUND

### Technical Field

The disclosure relates to a vehicle panel structure.

### Description of Related Art

In recent years, efforts to provide access to sustainable transportation systems that also take into account vulnerable persons such as the elderly, the disabled, and children among traffic participants have been active. In order to achieve the stated purpose, research and development efforts are made to further improve the safety and convenience of transportation through development related to collision safety performance. Generally, vehicle body rigidity affects the stability of load transfer to the vehicle body, which in turn affects collision safety performance. Therefore, in the related art, various research and development has been conducted on how to smoothly transfer loads from the outside to the vehicle body.

Specifically, during a collision, loads from the outside typically cause the frame structure to deform and thereby absorb energy. If the frame structure has a panel with a large cross-section, the load will not be applied to areas except at the corners. Therefore, generally speaking, the panel structure is one with low Specific Energy Absorption (SEA), which is defined as the energy absorbed by a crushed member per unit mass. Furthermore, when a panel with a large cross-section in the frame structure is flattened, its cross-section deforms and protrudes, and the load will not increase again until the section is completely crushed. Therefore, once the structure begins to deform, the load on the structure decreases, and the energy absorption value cannot continue to increase. As such, since the panel structure cannot be used efficiently to absorb energy during a collision, it is difficult to balance collision safety performance and lightweight requirements.

For example, Patent Document 1 (Japanese Patent Application Laid-Open No. 7411522) discloses a structure that improves collision performance by reducing the difference between peak load and average load during the collision process. This is achieved by disposing transverse reinforcement ribs, longitudinal reinforcement ribs, or curved reinforcement ribs on the panel surface to reduce the difference between collision load and average load. Although Patent Document 1 sets up a structure that absorbs impact loads through the shape of reinforcement ribs, when each panel of Patent Document 1 absorbs loads, it may cause each panel to deform in the same positional direction and be crushed, making it unable to continuously absorb energy.

In order to solve the issues, the disclosure aims to improve collision safety performance and realize lightweight structure, thereby contributing to the development of a sustainable transportation system.

### SUMMARY

The disclosure provides a vehicle panel structure that may absorb energy well during collision and achieve lightweight of the structure.

The disclosure provides a vehicle panel structure, including a panel, formed by a double-layer panel structure having a first panel and a second panel, where the panel has concave ribs and convex ribs formed to be concavo-convex in a normal direction of the panel, the concave ribs or the convex ribs formed on the first panel are first ribs, the concave ribs or the convex ribs formed on the second panel are second ribs, each first rib and each second rib correspond to each other respectively, and overlap in the normal direction of the panel, and when one of the corresponding first ribs and second ribs is one of the concave ribs and the convex ribs, the other one of the corresponding first ribs and second ribs is the other one of the concave ribs and the convex ribs.

Based on the above, in the embodiments of the disclosure, the vehicle panel structure controls the deformation behavior when subjected to impact through the profiles of the concave ribs or the convex ribs formed on the panel, and may cause deformation in the cross-section of a wider range of the panel, thereby increasing the load bearing capacity, and minimizing the situation of load decrease when deformation begins. Moreover, by forming catenary-shaped concave ribs or convex ribs (circular curved concave ribs or convex ribs), the panel may move stably and significantly, triggering secondary collisions between the first panel and the second panel. Furthermore, through the configuration where the first panel and the second panel abut against each other at the position where the panel deforms inward during deformation, the absorbed load may be increased through the secondary collisions between the first panel and the second panel within the cross-section of the vehicle panel structure, thereby increasing the magnitude of energy absorption. In addition, through the configuration method of the concave ribs or the convex ribs of the vehicle panel structure, the direction of deformation of the first panel and the second panel of the vehicle panel structure may be changed, thus taking into account both the stabilization of the deformation behavior of the vehicle panel structure and the capacity for high load. As such, compared to past vehicle panel structures that were unable to efficiently absorb energy in collisions, the vehicle panel structure may also be efficiently utilized during collisions, constructing a structure that may efficiently absorb energy even for thin plates with large cross-sections, thereby enabling good energy absorption during collisions and achieving lightweight of the structure.

In order to make the above-mentioned features and advantages of the disclosure more comprehensible, the following specific embodiments are described in detail with reference to the accompanying drawings.

### BRIEF DESCRIPTION OF THE DRAWINGS

FIG. 1 is a structural schematic diagram of a vehicle panel structure according to an embodiment of the disclosure.

FIG. 2 is a structural schematic diagram of a vehicle panel structure according to another embodiment of the disclosure.

FIG. 3 is a schematic diagram of the concave rib or the convex rib when transferring load as shown in FIG. 1 or FIG. 2.

### DESCRIPTION OF THE EMBODIMENTS

In an embodiment of the disclosure, orthographic projections of the concave ribs or the convex ribs formed on the panel are in a curved state.

In an embodiment of the disclosure, the panel has a central part and an end part, and curve opening directions of the orthographic projections of the concave ribs or the convex ribs formed in the central part on the panel are opposite to curve opening directions of the orthographic projections of the concave ribs or the convex ribs formed in the end part on the panel.

In an embodiment of the disclosure, a support member is disposed inside the panel, where a length direction of the support member is a load input direction, and the support member is located between the central part and the end part.

In an embodiment of the disclosure, a plurality of the concave ribs or the convex ribs are disposed along a load input direction, and the concave ribs and the convex ribs are configured adjacently in the load input direction.

In an embodiment of the disclosure, in at least any one of the first panel and the second panel, when one of the concave ribs or the convex ribs is formed in the central part, the other one of the concave ribs or the convex ribs is formed in the end part.

In an embodiment of the disclosure, a support member is disposed inside the panel, where a length direction of the support member is a load input direction, and the support member is located between the concave ribs and the convex ribs of the first panel or the second panel.

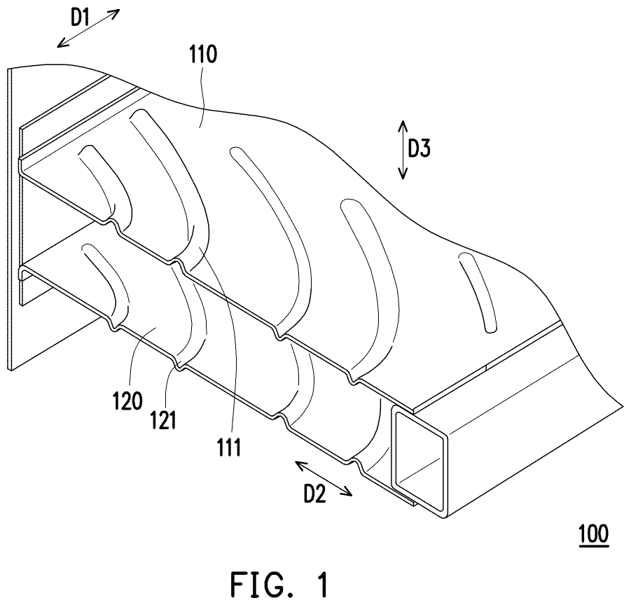

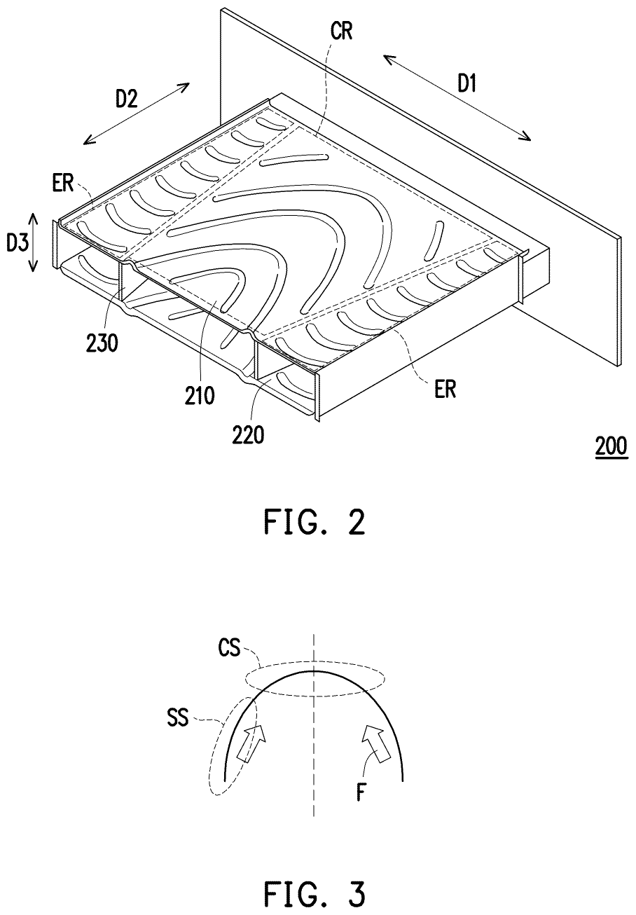

FIG. 1 is a structural schematic diagram of a vehicle panel structure according to an embodiment of the disclosure. FIG. 2 is a structural schematic diagram of a vehicle panel structure according to another embodiment of the disclosure. FIG. 3 is a schematic diagram of the concave rib or the convex rib when transferring load as shown in FIG. 1 or FIG. 2. The specific structure of a vehicle panel structure 100 will be described below with reference to FIG. 1 and FIG. 2 respectively, and the transfer direction when the concave rib or the convex rib shown in FIG. 1 or FIG. 2 transfers load will be described below with reference to FIG. 3. It should be noted that, for the sake of convenience, the transverse direction, longitudinal direction, and up-down direction of the vehicle panel structure 100 are defined as shown in the figure, and the constitution of each part is described according to this definition. The transverse direction, longitudinal direction, and up-down direction of the vehicle panel structure 100 correspond to a first direction D1 and a second direction D2 on the plane of the panel, and a normal direction D3 of the panel, respectively.

Referring to FIG. 1, in the embodiment, the vehicle panel structure 100 includes a panel, and the panel is formed by a double-layer panel structure having a first panel 110 and a second panel 120. Specifically, as shown in FIG. 1, in the embodiment, the panel has concave ribs and convex ribs formed to be concavo-convex in the normal direction D3 of the panel, where the concave ribs or the convex ribs formed on the first panel 110 are first ribs 111, the concave ribs or the convex ribs formed on the second panel 120 are second ribs 121, each first rib 111 and each second rib 121 correspond to each other respectively, and overlap in the normal direction D3 of the panel, and when one of the corresponding first ribs 111 and second ribs 121 is one of the concave ribs and convex ribs, the other one of the corresponding first ribs 111 and second ribs 121 is the other one of the concave ribs and convex ribs.

As such, through the structure where the first ribs 111 formed on the first panel 110 and the second ribs 121 formed on the second panel 120 in the double-layer panel structure overlap in the normal direction D3 of the panel, the vehicle panel structure 100 ensures that when the panel deforms through collision, the stress directions of bearing load (i.e., the normal direction of the first ribs 111 and the normal direction of the second ribs 121) of the first ribs 111 on the first panel 110 and the second ribs 121 on the second panel 120 are opposite. As such, it may form a part where the first panel 110 and the second panel 120 simultaneously deform in directions towards each other in the normal direction D3 (deform towards the interior of the double-layer panel structure), or it may form a part where the first panel 110 and the second panel 120 simultaneously deform to the opposite sides of the directions towards each other (deform towards the exterior of the double-layer panel structure). Accordingly, when the panel deforms, it enables to suppress the first panel 110 and the second panel 120 from bending in the same normal direction to fold the panel, so that it may suppress the overall structure from bending in the normal direction D3 during deformation, and may utilize the large section of the panel to continuously absorb load.

Moreover, as shown in FIG. 1, in the embodiment, the orthographic projections formed by the concave ribs or the convex ribs of the first panel 110 and the second panel 120 on the panel are in a curved state. Specifically, in the embodiment, the profiles of the orthographic projections formed by the concave ribs or the convex ribs of the first panel 110 and the second panel 120 on the panel are in a shape of a catenary or a circular curve. Furthermore, as shown in FIG. 1 and FIG. 3, the concave ribs or the convex ribs may be distinguished into straight sections SS and curved sections CS, where the curved sections CS of the concave ribs or the convex ribs have a larger component in the first direction D1 of the panel, the straight sections SS of the concave ribs or the convex ribs have a larger component in the second direction D2 of the panel, and, as shown in FIG. 1, in the embodiment, the load input direction is, for example, the second direction D2 of the panel. As such, as shown in FIG. 3, when a collision occurs and a load Fis input, the straight sections SS of the concave ribs or the convex ribs may be used to transfer the load F, and make the load F concentrated when it is transferred to the curved sections CS of the concave ribs or the convex ribs, causing the curved sections CS of the concave ribs or the convex ribs to become the trigger point for deformation. As such, it may control the deformation behavior when subjected to impact through the profiles of the concave ribs or the convex ribs of the panel. In addition, when the load Fis input, through the structure configuration where the concave ribs or the convex ribs are in a curved state, it may allow the straight sections SS to transfer the load F towards the center of the curved reinforcement ribs (i.e., the curved sections CS) and generate deformation. Therefore, it may cause deformation in the cross-section of a wider range of the panel, and may increase the load F borne, thus minimizing the situation of load decrease when deformation begins.

On the other hand, as shown in FIG. 1, in the embodiment, a plurality of the concave ribs or the convex ribs of the first panel 110 and the second panel 120 are disposed along the load input direction (the second direction D2), and the concave ribs and convex ribs are configured adjacently in the load input direction (the second direction D2). As such, since the concave ribs and convex ribs are formed adjacently to each other in the load input direction (the second direction D2), the first panel 110 and the second panel 120 will abut against each other at the position where the panel deforms inward during deformation. Therefore, even during the deformation process, the first panel 110 and the second panel 120 will exert force on each other until the end, thus enabling an increase in the ability of the overall structure to bear the load.

As a result, in the embodiment, the vehicle panel structure 100 controls the deformation behavior when subjected to impact through the profiles of the concave ribs or the convex ribs formed on the panel, and may cause deformation in the cross-section of a wider range of the panel, thereby increasing the load bearing capacity, and minimizing the situation of load decrease when deformation begins. Moreover, by forming catenary-shaped concave ribs or convex ribs (circular curved concave ribs or convex ribs), the panel may move stably and significantly, triggering secondary collisions between the first panel 110 and the second panel 120. Furthermore, through the configuration where the first panel 110 and the second panel 120 abut against each other at the position where the panel deforms inward during deformation, the absorbed load may be increased through the secondary collisions between the first panel 110 and the second panel 120 within the cross-section of the vehicle panel structure 100, thereby increasing the magnitude of energy absorption. In addition, through the configuration method of the concave ribs or the convex ribs of the vehicle panel structure 100, the direction of deformation of the first panel 110 and the second panel 120 of the vehicle panel structure 100 may be changed, thus taking into account both the stabilization of the deformation behavior of the vehicle panel structure 100 and the capacity for high load. In this way, compared to past vehicle panel structures 100 that were unable to efficiently absorb energy in collisions, the vehicle panel structure 100 may also be efficiently utilized during collisions, constructing a structure that may efficiently absorb energy even for thin plates with large cross-sections, thereby enabling good energy absorption during collisions and achieving lightweight of the structure.

On the other hand, FIG. 2 is a structural schematic diagram of a vehicle panel structure according to another embodiment of the disclosure. Referring to FIG. 2, in the embodiment, a vehicle panel structure 200 is similar to the vehicle panel structure 100 depicted in FIG. 1, and the differences between the two are described as follows. In the embodiment, the panel of the vehicle panel structure 200 has a central part CR and an end part ER, and the curve opening directions of the orthographic projections formed on the panel by the concave ribs or the convex ribs formed in the central part CR are opposite to the curve opening directions of the orthographic projections formed on the panel by the concave ribs or the convex ribs formed in the end part ER. That is to say, as shown in FIG. 2, in the embodiment, the orthographic projections of the concave ribs or the convex ribs formed in the central part CR on the panel are U-shaped, and their openings face the load input direction during collision, while the orthographic projections of the concave ribs or the convex ribs formed in the end part ER on the panel are also U-shaped, but their openings face away from the load input direction during collision. In this way, by making the curve opening directions of the concave ribs or the convex ribs in the central part CR and the end part ER of the panel opposite to each other, deformation in two directions may be formed. Thus, when the panel deforms, the direction in which the panel bears the load is reversed between the central part CR and the end part ER, thereby preventing the formation of bending points in the same direction at positions that overlap in the normal direction D3 of the panel, thus suppressing the collapse of the panel in the normal direction D3.

On the other hand, as shown in FIG. 2, in the embodiment, in at least one of the first panel 210 and the second panel 220, when one of the concave ribs or the convex ribs is formed in the central part CR, the other one of the concave ribs or the convex ribs is formed in the end part ER. In this way, in the panel, since the deformation direction of the central part CR and the end part ER is changed, the part that deforms towards the outside of the double-layer panel structure in the normal direction D3 may suppress the collapse caused by the internal deformation of the panel in the normal direction D3, thereby enabling an increase in the ability of the overall structure to bear the load. For example, if the concave ribs are formed on the central part CR and the convex ribs are formed on the end part ER, when the concave ribs of the central part CR causes the panel to deform inward in the normal direction D3, the convex ribs of the end part ER protrude outward from the panel in the normal direction D3, which may suppress the collapse of the panel in the normal direction D3, and at the same time, the central part CR of the panel may increase the ability of the overall structure to bear the load through panel deformation (absorption of load increased by the secondary collisions between the first panel 210 and the second panel 220).

In addition, as shown in FIG. 2, in the embodiment, a support member 230 is disposed inside the panel. A length direction of the support member 230 is the load input direction (the second direction D2). The support member 230 is located between the central part CR and the end part ER, and the support member 230 is located between the concave ribs and the convex ribs of the first panel 210 or the second panel 220. In this way, through the configuration of the support member 230, in addition to increasing the ability of the overall structure to bear the load, by placing the support member between the central part CR and the end part ER or positioning the support member 230 in the middle of the concave ribs and the convex ribs, the deformation area of the panel may be divided, thereby preventing the overlap situation of the panel in the normal direction D3, and thus preventing the collapse of the panel in the normal direction D3.

Moreover, since the vehicle panel structure 200 may also control the deformation behavior when subjected to impact through the profiles of the concave ribs or the convex ribs formed on the panel, and may take into account the stabilization of the deformation behavior of the vehicle panel structure 200 and the capacity for high load, it may absorb energy well during collision and achieve lightweight of the structure. Therefore, the vehicle panel structure 200 may also achieve similar effects and advantages as the aforementioned vehicle panel structure 100, which will not be repeated here.

In summary, in the embodiments of the disclosure, the vehicle panel structure controls the deformation behavior when subjected to impact through the profiles of the concave ribs or the convex ribs formed on the panel, and may cause deformation in the cross-section of a wider range of the panel, thereby increasing the load bearing capacity, and minimizing the situation of load decrease when deformation begins. Moreover, by forming catenary-shaped concave ribs or convex ribs (circular curved concave ribs or convex ribs), the panel may move stably and significantly, triggering secondary collisions between the first panel and the second panel. Furthermore, through the configuration where the first panel and the second panel abut against each other at the position where the panel deforms inward during deformation, the absorbed load may be increased through the secondary collisions between the first panel and the second panel within the cross-section of the vehicle panel structure, thereby increasing the magnitude of energy absorption. In addition, through the configuration method of the concave ribs or the convex ribs of the vehicle panel structure, the direction of deformation of the first panel and the second panel of the vehicle panel structure may be changed, thus taking into account both the stabilization of the deformation behavior of the vehicle panel structure and the capacity for high load. As such, compared to past vehicle panel structures that were unable to efficiently absorb energy in collisions, the vehicle panel structure may also be efficiently utilized during collisions, constructing a structure that may efficiently absorb energy even for thin plates with large cross-sections, thereby enabling good energy absorption during collisions and achieving lightweight of the structure.

Lastly, it should be noted that the above embodiments are used to describe the technical solution of the disclosure instead of limiting it. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure.

What is claimed is:

1. A vehicle panel structure, comprising:
a panel, formed by a double-layer panel structure having a first panel and a second panel,
wherein the panel has concave ribs and convex ribs formed to be concavo-convex in a normal direction of the panel, the concave ribs or the convex ribs formed on the first panel are first ribs, the concave ribs or the convex ribs formed on the second panel are second ribs, each first rib and each second rib correspond to each other respectively, and overlap in the normal direction of the panel, and when one of the corresponding first ribs and second ribs is one of the concave ribs and the convex ribs, the other one of the corresponding first ribs and second ribs is the other one of the concave ribs and the convex ribs.

2. The vehicle panel structure according to claim 1, wherein
orthographic projections of the concave ribs or the convex ribs formed on the panel are in a curved state.

3. The vehicle panel structure according to claim 2, wherein
the panel has a central part and an end part, and curve opening directions of the orthographic projections of the concave ribs or the convex ribs formed in the central part on the panel are opposite to curve opening directions of the orthographic projections of the concave ribs or the convex ribs formed in the end part on the panel.

4. The vehicle panel structure according to claim 3, wherein
a support member is disposed inside the panel, a length direction of the support member is a load input direction, and the support member is located between the central part and the end part.

5. The vehicle panel structure according to claim 2, wherein
a plurality of the concave ribs or the convex ribs are disposed along a load input direction, and the concave ribs and the convex ribs are configured adjacently in the load input direction.

6. The vehicle panel structure according to claim 3, wherein
in at least any one of the first panel and the second panel, when one of the concave ribs or the convex ribs is formed in the central part, the other one of the concave ribs or the convex ribs is formed in the end part.

7. The vehicle panel structure according to claim 6, wherein
a support member is disposed inside the panel, a length direction of the support member is a load input direction, and the support member is located between the concave ribs and the convex ribs of the first panel or the second panel.
